(19) United States
(12) Patent Application Publication
(10) Pub. No.: US 2024/0368501 A1
(43) Pub. Date: Nov. 7, 2024

(54) ACIDIC LIQUID FABRIC CARE COMPOSITIONS

(71) Applicant: The Procter & Gamble Company, Cincinnati, OH (US)

(72) Inventors: Shelby Phillip SALLEY, Cincinnati, OH (US); Sarah Ann DELANEY, Hebron, KY (US); Jennifer Lea RINKER, Hamilton, OH (US); Rachel Morgan Clayton ROEDER, Mason, OH (US)

(21) Appl. No.: 18/310,789

(22) Filed: May 2, 2023

(51) Int. Cl. C11D 3/20; C11D 1/72; C11D 3/50

(52) U.S. Cl. CPC C11D 3/2086; C11D 1/72; C11D 3/50

(57) ABSTRACT

Acidic liquid fabric care compositions that include citric acid and/or a salt thereof, a nonionic surfactant that has a Stability Parameter between 11.0 and 25.0, and water. Related methods of using and making such compositions.

### FIELD OF THE INVENTION

The present disclosure relates to an acidic liquid fabric care composition that includes citric acid and/or a salt thereof, fragrance material, water, and a nonionic surfactant that is an ethoxylated fatty alcohol and has an HLB of between 12.0 and 13.9 and a Stability Parameter between 11.0 and 25.0. The present disclosure also relates to methods of using and making such compositions.

### BACKGROUND OF THE INVENTION

Certain liquid fabric care compositions that have a low pH and low-to-nil amounts of softeners or bleach can still be useful for providing fabric care benefits, particularly as through-the-rinse applications in automatic washing machines. For example, such compositions can provide softening benefits and/or be useful in for removing limescale that may accumulate on fabrics, such as towels, particularly when the fabrics have been washed in hard water.

Such compositions may include relatively high levels of citric acid and/or related salts. Fragrance materials (e.g., perfume) may also be added to the compositions in order to improve the neat product odor and/or to provide freshness benefits to the target fabrics upon treatment.

However, it has been found that such compositions may experience physical stability issues upon storage, which may signal product degradation and/or reduced efficiency to the consumer. There is a need for improved low-pH fabric care compositions that include fragrance materials.

### SUMMARY OF THE INVENTION

The present disclosure relates to liquid fabric care composition that have fragrance materials, a specific nonionic surfactant, and are characterized by a relatively low pH.

For example, the present disclosure relates to a liquid fabric care composition that includes: from about 10% to about 50%, by weight of the liquid fabric care composition, of citric acid and/or a salt thereof; from about 0.01% to about 20% of fragrance material, from about 30% to about 90%, by weight of the liquid fabric care composition, of water; from about 0.1% to about 8%, by weight of the liquid fabric care composition, of nonionic surfactant, wherein the nonionic surfactant is an ethoxylated fatty alcohol that has an HLB of between 12.0 and 13.9 and a Stability Parameter between 11.0 and 25.0, where the liquid fabric care composition is characterized by a neat pH of from about 2 to about 6.

The present disclosure also relates to a method of treating a fabric, where the method includes the step of contacting the fabric with a liquid fabric care composition as described herein.

The present disclosure also relates to a method of making a liquid fabric care composition as described herein, where the method includes the step of combining water, citric acid, and a fragrance material, preferably where the fragrance material is premixed with nonionic surfactant.

### DETAILED DESCRIPTION OF THE INVENTION

The present disclosure relates to acidic liquid fabric care compositions. The compositions include citric acid, fragrance material, water, and a nonionic surfactant that is an ethoxylated fatty alcohol and has an HLB of between 12.0 and 13.9 and a Stability Parameter between 11.0 and 25.0. Such compositions are believed to be relatively more physically stable when assessed against comparative compositions that include nonionic surfactants that are not characterized as detailed above.

Without wishing to be bound by theory, it is believed that fragrance materials, which are often desirable from an olfactory/freshness point of view, may, over time, tend to lead to phase separation in aqueous acidic fabric care treatment compositions. In other words, the presence of fragrance materials in the composition may have the tendency to cause the composition to separate from a single continuous aqueous phase, thus forming two phases (an aqueous phase and a separate oily phase). This results in a challenge for the formulator, as fragrance materials are often preferred to provide a pleasant olfactory experience to the consumer during use and on the treated fabrics.

The present disclosure provides a solution to this choice between product phase stability and a desired freshness profile. It has surprisingly been found that selecting certain nonionic surfactants and/or pairing certain nonionic surfactants with certain perfume materials, results in aqueous acidic fabric care treatment compositions that experience a surprisingly high level of phase stability. Aqueous acidic fabric care treatment compositions are often high in water content and high in salt content (e.g., high citric acid levels) and many fragrance materials do not mix well in such hydrophilic environments. Such selected nonionic surfactants (as detailed herein) are thought to form small hydrophobic micelles to shelter the fragrance materials, suspending the fragrance materials, while also not impacting the composition's aesthetics (i.e., causing the composition to become hazy/opaque instead of the desired clear liquid aesthetic). The compositions and related methods are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

As used herein the term “stable” or “phase stable” or “physically phase stable” means that a liquid composition is characterized by having only a single, clear, visible phase (i.e., a single, transparent liquid). A stable liquid composition may have a transmittance of greater than about 95%, where % transmittance equals:

$$\frac{1}{{10}^{absorbancy}} \times 100 \%$$

A composition is “not stable” or “phase unstable” or “physically phase unstable” if the liquid composition is characterized as having more than one visible phase (i.e., the liquid composition has separated into two or more visible, distinct portions) or has an overall opaque/cloudy appearance.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Composition

The present disclosure relates to liquid fabric care compositions that have a relatively low pH. Put another way, the present disclosure relates to acidic, liquid fabric care compositions.

The compositions of the present disclosure may be particularly useful for treating fabrics, such as garments or towels, during the rinse cycle of an automatic washing machine. Due to the low pH of the compositions, they can be useful for softening fabrics and/or for rejuvenating colors by removing limescale that may have accumulated on the fabrics, which can result from washing one's fabrics in hard water.

The compositions comprise citric acid and/or a salt thereof. As one of ordinary skill will realize, the citric acid and a salt thereof may exist in an equilibrium in the liquid composition. Citric acid is preferred for use in the present compositions due to being both a performance-efficient and cost-efficient material, as well as being readily available.

The compositions may comprise from about 10% to about 50%, by weight of the liquid fabric care composition, of citric acid and/or a salt thereof. The liquid fabric care composition may comprise from about 15% to about 40%, preferably from about 20% to about 30%, by weight of the liquid fabric care composition, of the citric acid and/or the salt thereof.

The liquid fabric care compositions of the present disclosure comprise a fragrance material (also herein “fragrance” or “perfume”). The fragrance materials are added to provide aesthetically pleasing scent to the liquid product composition, to a treatment liquor, and/or to fabrics treated with the composition. The compositions of the present disclosure may include from about 0.1% to about 20%, or from about 0.1% to about 5%, or from about 0.2% to about 10%, or from about 0.3% to about 5%, by weight of the composition, of fragrance materials.

Non-limiting examples of fragrance materials include, but are not limited to, aldehydes, ketones, esters, and the like. Other examples include various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes can comprise extremely complex mixtures of such ingredients.

At least a portion of the fragrance materials of the present disclosure may be derived from naturally sourced materials. It is believed that such materials have a lesser environmental impact and/or are more environmentally sustainable compared to synthetically derived and/or geologically derived (such as petroleum-based) materials. At least about 50%, or at least about 60%, or at least about 70%, or at least about 80%, or at least about 90%, or at least about 95%, or about 100%, by weight of the fragrance materials, of the fragrance materials may be naturally derived fragrance materials.

Because the compositions of the present disclosure are typically characterized by a relatively low pH, the fragrance materials of the present disclosure are typically acid-stable, particularly at the pH of the composition. Acid stability may qualitatively be shown by the lack of phase separation, a lack of discoloration, and/or a lack of precipitate formation at an acidic pH upon storage, preferably at a pH of from about 2 to about 4.

To facilitate convenient incorporation of the fragrance material into the aqueous compositions of the present disclosure, the fragrance material may be first mixed with a nonionic surfactant or other emulsifier prior to being mixed with the water and/or citric acid. Put another way, the composition may be made by a process in which the fragrance material is mixed with nonionic surfactant prior to being mixed with the citric acid.

The liquid fabric care compositions of the present disclosure are typically aqueous compositions. The liquid fabric care compositions typically comprise water. The compositions may comprise from about 30% to about 90%, by weight of the liquid fabric care composition, of water. The composition may comprise from about 50% to about 90% water, preferably from about 60% to about 85%, more preferably from about 70% to about 80%, by weight of the liquid fabric care composition.

Although the fabric treatment compositions of the present disclosure are aqueous, the compositions may further comprise organic solvent, which can improve composition stability, ingredient dissolution, and/or transparency of the composition. The fabric treatment compositions may include from about 0.1% to about 30%, or from about 1% to about 20%, by weight of the composition, of organic solvent. Suitable organic solvents may include ethanol, diethylene glycol (DEG), 2-methyl-1,3-propanediol (MPD), monopropylene glycol (MPG), dipropylene glycol (DPG), oligamines (e.g., diethylenetriamine (DETA), tetraethylenepentamine (TEPA)), glycerine, propoxylated glycerine, ethoxylated glycerine, ethanol, 1,2-propanediol (also referred to as propylene glycol), 1,3-propanediol, 2,3-butanediol, cellulosic ethanol, renewable propylene glycol, renewable monopropylene glycol, renewable dipropylene glycol, renewable 1,3-propanediol, and mixtures thereof. One or more of the organic solvents may be bio-based, meaning that they are derived from a natural/sustainable, non-geologically-derived (e.g., non-petroleum-based) source.

The liquid fabric care compositions of the present disclosure may comprise a hydrotrope, such as sodium cumene sulphonate (SCS), which may help with the stability of the composition.

The compositions of the present disclosure may comprise one or more nonionic surfactant, which may help with product stability and/or incorporation of the fragrance materials. The composition may comprise from about 0.1 to about 8%, preferably from about 1% to about 5%, by weight of the liquid fabric care composition, of nonionic surfactant. The nonionic surfactant is preferably an ethoxylated fatty alcohol. The nonionic surfactant may be premixed with the fragrance materials.

The nonionic surfactant may be characterized by one or more of several different parameters, including but not limited to, Weighted Average Degree of Ethoxylation, Average Cloud Point, and HLB. Methods to measure each of these parameters is further detailed herein.

The nonionic surfactant may be characterized by its Weighted Average Degree of Ethoxylation. In a population of nonionic surfactant, the nonionic surfactant molecules may have varying degrees of ethoxylation. Thus, a given amount or sample of nonionic surfactant may be characterized by a Weighted Average Degree of Ethoxylation, where the degree of ethoxylation is reported as moles of ethoxy groups (—O—CH2-CH2) per mole of nonionic surfactant. The nonionic surfactant of the present disclosure may be characterized by a Weighted Average Degree of Ethoxylation of from about 7.0 to about 12.0, or from about 8.0 to about 11.0, or from about 9.0 to about 10.0, or about 9.0.

The nonionic surfactant may be characterized by its Average Cloud Point. Average Cloud Point is the temperature above which a surfactant rich phase separates from an aqueous phase. The separation occurs when a nonionic surfactant becomes insoluble due to increased heat, resulting in a cloudy or hazy dispersion in the solution. The nonionic surfactant of the present disclosure may be characterized by an Average Cloud Point of from about 60° C. to about 95° C., or from about 65° C. to about 85° C., or from about 70° C. to about 80° C., or about 75° C.

The nonionic surfactant may be characterized by its HLB. HLB, or Hydrophile-Lipophile Balance, is a numerical system used to describe the relationship between the water-soluble and oil-soluble parts of a nonionic surfactant. The nonionic surfactant of the present disclosure may be characterized by an HLB of between about 12.0 to about 14.0, or from about 12.5 to about 13.9, or from 12.5 to 13.9, or from about 12.5 to about 13.5, or from about 12.8 to about 13.2, or about 13.

The nonionic surfactant may be further characterized by a Stability Parameter that takes into account Weighted Average Degree of Ethoxylation, Average Cloud Point, and HLB. Stability Parameter is defined as follows:

$$Stability Parameter = \frac{Average Cloud Point}{( HLB - Weighted Average Degree of Ethoxylation )}$$

The nonionic surfactants of the present disclosure may be characterized by a Stability Parameter of between about 11.0 and about 25.0, or between 11.0 and 25.0, or between about 13.0 and about 20.0, or between about 18.0 and about 19.0. The following Table A lists various nonionic surfactants and associated parameters.

TABLE A

| | | Weighted | | |
|---|---|---|---|---|
| | | Average Degree | Average | Stability |
| Name of Nonionic Surfactant | HLB | of Ethoxylation | Cloud Point | Parameter |
| Lutensol XP79 | 13.2 | 7 | 68 | 10.97 |
| Lutensol XP80 | 14.0 | 8 | 75 | 12.5 |
| Novel 1412-3 | 7.9 | 3 | 59 | 12.04 |
| Novel 1412-11 (NRE) | 14.0 | 11 | 78 | 26.0 |
| Terigol 15-S-12 | 14.5 | 12 | 89 | 35.6 |
| Terigol 15-S-20 | 16.3 | 20 | 100 | −27.03 |
| Novel 1214-9 (NRE) | 13.0 | 9 | 86 | 21.5 |
| Triton X-100 | 13.4 | 9.5 | 66 | 16.92 |
| Terigol 15-S-7 | 12.1 | 7 | 37 | 7.25 |
| Terigol TMN-6 | 13.1 | 8 | 36 | 7.06 |
| Neodol 45-7 | 11.8 | 7 | 46 | 9.58 |
| Lutensol XP70 | 13.2 | 7 | 68 | 10.97 |
| Surfonic L24-7 (NRE) | 11.9 | 7 | 51 | 10.41 |
| Terigol 15-S-9 | 13.3 | 9 | 60 | 13.95 |
| Terigol NP-10 | 13.2 | 10 | 63 | 19.69 |
| Surfonic L24-9 (NRE) | 13.0 | 9 | 86 | 21.50 |
| Surfonic L24-9 | 13.0 | 9 | 75 | 18.75 |
| Alfonic 1214-7 | 12.1 | 7 | 60 | 11.76 |
| Alfonic 1214--9 | 13.3 | 9 | 80.5 | 18.72 |

Of the nonionic surfactants listed in Table A, there is particular interest in Novel 1214-9 (NRE), Triton X-100, Terigol 15-S-9, Terigol NP-10, Surfonic L24-9 (NRE), Surfonic L24-9, Alfonic 1214-7, and Alfonic 1214-9.

In addition to the citric acid and/or salt thereof, the liquid fabric care composition may further comprise an additional organic acid. The additional organic acid may be selected from the group consisting of acetic acid, lactic acid, adipic acid, aspartic acid, carboxymethyloxymalonic acid, carboxymethyloxysuccinic acid, glutaric acid, hydroxyethlyliminodiacetic acid, iminodiactic acid, maleic acid, malic acid, malonic acid, oxydiacetic acid, oxydisuccinic acid, succinic acid, sulfamic acid, tartaric acid, tartaric-discuccinic acid, tartaric-monosuccinic acid, or mixtures thereof, preferably acetic acid. It may be preferred that the composition is substantially free of an additional organic acid. It may be preferred that the composition is substantially free of acetic acid, which can add undesirable odors.

The liquid fabric care compositions of the present disclosure are acidic compositions. A low pH is believed to facilitate the benefits provided (e.g., limescale removal) by the present compositions. For example, the composition may be characterized by a neat pH of from about 2 to about 6, preferably from about 2 to about 5, preferably from about 2 to about 4, more preferably from about 2 to about 3. These ranges of pH are believed to facilitate the performance efficacy of the citric acid and/or salts thereof.

The compositions of the present disclosure may comprise a neutralizing agent, which can aid in achieving a desired pH. The neutralizing agent is preferably a caustic neutralizing agent, more preferably sodium hydroxide (NaOH). It is believed that strong bases, such as caustic neutralizing agents like NaOH, can provide physical stability benefits relative to weak bases, such as monoethanolamine (MEA).

The liquid fabric care compositions of the present disclosure may comprise a limited number of ingredients, for example, no more than ten, or no more than nine, or no more than eight, or no more than seven, or no more than six, or no more than five ingredients. Limiting the number of ingredients can result in lower storage and/or transportation costs of raw materials, and/or simplify the process of making the compositions. Consumers may also desire products having a limited number of ingredients, as they may be perceived as simpler, as having a smaller environmental footprint, and/or as providing an easier-to-understand ingredient list.

The liquid fabric care composition may comprise less than 10%, by weight of the liquid fabric care composition, of a material selected from the group consisting of detersive surfactant, bleaching systems, fabric softening materials, and mixtures thereof. The composition may comprise less than 8%, preferably less than 5%, preferably less than 4%, preferably less than 2.5%, preferably less than 1%, or even is substantially free of a material selected from the group consisting of detersive surfactant, bleaching systems, and/or fabric softening materials. Such materials may affect the aesthetics, physical stability, and/or chemical stability of the other ingredients in the present compositions. Additionally or alternatively, certain such materials may not be physically or chemically stable themselves in low-pH environment of the present compositions. Furthermore, consumers who use the present compositions may be hoping to remove materials from their treated fabrics, whereas at least some of the listed materials may instead deposit on fabric during a normal treatment cycle, building up undesirable residues.

The present compositions may be substantially free of detersive surfactants, including anionic, amphoteric, and/or zwitterionic surfactants. Anionic surfactants may include: sulfated surfactants, such as alkyl sulfate or alkoxylated alkyl sulfate; sulfonated surfactants, such as (linear) alkyl benzene sulfonates; and/or carboxylated surfactants. Nonionic surfactants may include: alkoxylated fatty alcohols; alkoxylated alkyl phenols; and/or alkyl polyglucosides. Zwitterionic surfactants may include amine oxide and/or betaines.

The liquid fabric care composition may comprise less than 5%, preferably less than 3%, more preferably less than 1%, even more preferably less than 0.1%, by weight of the composition, of anionic surfactant.

As mentioned above, the liquid fabric care composition may comprise a specific nonionic surfactant. When the composition comprises that specific nonionic surfactant, the composition may be substantially free of other (non-nonionic) surfactants.

The present compositions may be substantially free of bleaching systems. Bleaching systems may include peroxide bleaches, such as hydrogen peroxide and/or sources of peroxide. Bleaching systems may include hypohalite bleaches, such as hypochlorite bleaches, or sources of such hypohalites. Bleaching systems may also include bleach activators, such as NOBS or TAED, or bleach catalysts.

The present compositions may be substantially free of fabric softening materials. Such materials may deposit on fabric, which may be less preferred for certain consumers, applications, or fabrics. Additionally or alternatively, such materials may require emulsification or other processing to make them compatible with the present aqueous compositions. Fabric softening materials may be cationically charged and/or capable of becoming cationically charged in typical wash conditions. Fabric softening materials may include quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, or combinations thereof. As used herein, the terms “fabric softening materials” is not intended to include any of the materials listed as organic acids above, including citric acid or acetic acid (e.g., vinegar).

The liquid fabric care compositions of the present disclosure may be relatively transparent. For example, the composition may be characterized by a percent transmittance (% T) of at least about 60% of light using a one-centimeter cuvette, at a wavelength of about 410-800 nanometers when the composition is substantially free of dyes.

As described above, the present compositions may be relatively transparent. Therefore, the present composition may be substantially free of particles, such as encapsulated benefit agents, silicone droplets, pearlescent agents, and/or opacifiers, which may reduce the relative transparency of the composition. The present compositions may be substantially free of optical brighteners. The present compositions may be substantially free of dyes. As used herein the term “dye” includes aesthetic dyes that modify the aesthetics of the cleaning composition as well as dyes and/or pigments that can deposit onto a fabric and alter the tint of the fabric. Dyes are intended to include colorants, pigments, and hueing agents. Depending on the desired application or aesthetics, the composition may comprise dye, preferably an aesthetic dye.

The liquid fabric care compositions of the present disclosure may be characterized by a relatively low viscosity. Such viscosities may be desirable for convenient pouring and/or little hang-up in a machine's dispenser drawer. The composition may be characterized by a viscosity of from about from about 0 to about 200 cps, preferably from about 0 to about 100 cps, more preferably from about 0 to about 60 cps, as determined by rotational viscometry using a Brookfield viscometer and ASTM D 2196-99 at 60 RPM and 22° C. The composition may be characterized by a viscosity of less than about 100 cps.

In an effort to keep viscosity low, the compositions of the present disclosure may be substantially free of thickeners or other rheology enhancers, such as structurants. The compositions may be substantially free of salts, such as inorganic salts like sodium chloride, magnesium chloride, and/or calcium chloride, that can provide rheology modification such as thickening. As used herein, such salts are not intended to include the neutralization products of the organic acids described herein.

The liquid fabric care compositions described herein can be packaged in any suitable container, including those constructed from paper, cardboard, plastic materials, and any suitable laminates. The container may contain renewable and/or recyclable materials.

The compositions may be packaged in a transparent or translucent container. It may be preferred to package a transparent fabric care composition in a transparent or translucent container, such as a transparent or translucent bottle. The container may have a transmittance of more than about 25%, or more than about 30%, or more than about 40%, or more than about 50% in the visible part of the spectrum (approx. 410-800 nm). Alternatively, absorbency of the bottle may be measured as less than about 0.6 or by having transmittance greater than about 25%, where % transmittance equals:

$$\frac{1}{{10}^{absorbancy}} \times 100 \%$$

For purposes of this disclosure, as long as one wavelength in the visible light range has greater than about 25% transmittance, it is considered to be transparent/translucent.

Clear bottle materials that may be used include but are not limited to: polypropylene (PP), polyethylene (PE), polycarbonate (PC), polyamides (PA) and/or polyethylene terephthalate (PETE), polyvinylchloride (PVC); and polystyrene (PS). Recyclable materials may be preferred for environmental reasons.

The container or bottle may be of any form or size suitable for storing and packaging liquids for household use. For example, the container may have any size but usually the container will have a maximal capacity of about 0.05 to about 15 L, or about 0.1 to about 5 L, or from about 0.2 to about 2.5 L. The container may be suitable for easy handling. For example, the container may have handle or a part with such dimensions to allow easy lifting or carrying the container with one hand. The container may have a means suitable for pouring a liquid detergent composition and means for reclosing the container. The pouring means may be of any size or form. The closing means may be of any form or size (e.g., to be screwed or clicked on the container to close the container). The closing means may be cap, which can be detached from the container. Alternatively, the cap may be attached to the container, whether the container is open or closed. The closing means may also be incorporated in the container.

### Method of Treatment

The present disclosure relates to a method of treating a fabric. The method includes the step of contacting the fabric with a liquid fabric care composition according to the present disclosure.

The contacting step may occur in the presence of water. The contacting step preferably occurs during a rinse cycle of an automatic washing machine.

The composition may be dispersed or dissolved in water, forming a treatment liquor. The pH of the treatment liquor may be greater (e.g., closer to seven) than the pH of the liquid fabric care composition. The treatment liquor may be characterized by a pH of from about 2, or from about 3, or from about 4 to about 7, or to about 6, or to about 5. The organic acid system (e.g., the citric acid and optional additional organic acids) of the fabric care composition may be selected so as to substantially buffer the treatment liquor to a desired pH. Additionally or alternatively, the fabric care composition may include other buffers or pH-balancing agents to deliver a desired pH in the treatment liquor.

The compositions are typically employed at concentrations of from about 500 ppm to about 15,000 ppm in solution (i.e., the treatment liquor).

The water temperature may range from about 5° C. to about 90° C. The weight ratio of the treatment liquor to fabric may be from about 1:1 to about 30:1.

The process may be a manual process, such as in a wash basin, or it may be an automatic process, occurring the drum of an automatic laundry machine. The machine may be a top-loading machine or a front-loading machine. The compositions of the present disclosure may be manually provided to the drum of an automatic washing machine, or they may be automatically provided, for example via a dispenser drawer or other vessel.

Typical treatment processes include at least one wash cycle and at least one subsequent rinse cycle. Fabrics may be treated with surfactant, such as anionic surfactant, during the wash cycle. The composition may be preferably provided to the drum, and/or the fabrics may be contacted with the composition, during a rinse cycle.

### Method of Making

The present disclosure relates to a method of making a liquid fabric care composition as described herein. The method may include the step of combining water, citric acid and/or salts thereof, a fragrance material as described herein, and water, for example amounts suitable for obtaining the wt %'s described herein. Preferably, the fragrance material is premixed with nonionic surfactant.

Any suitable processes known in the art may be used, for example batch processes, in-line mixing, and/or circulation-loop-based processes.

The method of making may include the steps of: providing an aqueous base, which may simply be water; adding citric acid, which may be part of an aqueous solution, such as a 50% citric acid solution; and adding fragrance material, which may be premixed with nonionic surfactant. Other optional materials, such as neutralizing agent, hydrotrope, additional surfactant and/or solvent, may be added as desired.

The aqueous base includes water. The aqueous base may include at least 50%, or at least 60%, or at least 70%, or at least 75%, or at least 80%, or at least 85%, or at least 90%, or at least 95%, by weight of the aqueous base, of water.

### Test Methods

### Method for Measuring Average Cloud Point

The cloud point temperature is a characteristic that can be measured according to the standard test method ASTM 2024-09 (2017). The method measures the temperature where a surfactant concentration at 1.0% in DI water transitions from a completely soluble one phase system to a two-phase system, making the sample look cloudy. The typical temperature range tested includes 30 C to 95 C. The Average Cloud Point is the average of replicates or the midpoint when the cloud point is reported with a range by the supplier.

### Method for Measuring HLB and Weighted Average Degree of Ethoxylation

The surfactant system of the present compositions comprises a nonionic surfactant. In one aspect, the nonionic surfactant is selected from ethoxylated alcohols (also known as fatty alcohol ethoxylates) having an average of from about 10 to about 16 carbon atoms in the alcohol and an average degree of ethoxylation of from about 1 to about 12 moles of ethylene oxide per mole of alcohol.

A shorthand method of naming a fatty alcohol ethoxylate refers to its number of carbons in the alkyl chain and its average number of ethoxylate (EO) groups. For example, a fatty alcohol ethoxylate with from twelve to fourteen carbon atoms in its alkyl chain and an average of nine ethoxylate groups can be written as C24-9. This naming convention is used in this application.

Nonionic surfactants can be classified by the balance between the hydrophilic and lipophilic moieties in the surfactant molecule. The hydrophile-lipophile balance (HLB) scale devised by Griffin in 1949 is a scale from 0-20 (20 being Hydrophilic) used to characterize the nature of surfactants. The HLB of a surfactant may be calculated as follows:

$$HLB = 20 * Mh / M$$

where Mh is the molecular mass of the hydrophilic portion of the molecule, and M is the molecular mass of the whole molecule, giving a result on a scale of 0 to 20. An HLB value of 0 corresponds to a completely lipophilic/hydrophobic molecule, and a value of 20 corresponds to a completely hydrophilic/lipophobic molecule. See Griffin, W. C. Calculation of HLB values of Nonionic Surfactants, J. Soc. Cosmet. Chem. 1954, 5, 249-256. The HLB values for commonly used surfactants are readily available in the literature (e.g., HLB Index in Mccutcheon's Emulsifiers and Detergents, MC Publishing Co., 2004). The HLB value for a mixture of surfactants can be calculated as a weighted average of the HLB values of the surfactants.

A typical nonionic alcohol ethoxylate surfactant has the following formula:

H₃C—(CH₂)ₘ—(O—CH₂—CH₂)ₙ—OH

The (H₃C—(CH₂)ₘ) portion of the formula is the hydrophobic portion, and the ((O—CH₂—CH₂)ₙ—OH) portion is the hydrophilic portion. The molar mass of the hydrophobic CH₃—(CH₂)ₘ portion (Mp) is calculated using the equation 15+(m)*14 where m=average chain length−1. The molar mass of the hydrophilic portion (Mh) can be calculated by n*44+17, where n is the number of ethoxylate groups (EO). Typical surfactants of this type can have a broad distribution of degrees of ethoxylation, since species having various ethoxylate chain lengths are difficult to separate, or even to identify, in the commercially available materials. When a degree of ethoxylation is specified hereinafter, it will be understood that this refers to the Weighted Average Degree of ethoxylate moieties per molecule of surfactant.

Table B below shows a non-limiting list of an exemplary nonionic surfactant and corresponding HLB values. The HLB value is calculated using the equation referenced above. Commercially available nonionic surfactants typically consist of a distribution of alcohol chain lengths. To estimate the molar mass, an average chain length is used, unless otherwise specified in the material specifications.

TABLE B
Exemplary nonionic surfactants and HLB values

| | Average | | Hydro- | Hydro- | | |
|---|---|---|---|---|---|---|
| | Chain | | phobic | philic | | |
| | Length | # EO | portion | portion | Total | |
| Surfactants | (m) | (n) | (Mp) | (Mh) | (M) | HLB |
| C24 - 9 | 13 | 9 | 183 | 413 | 596 | 13.9 |

A sample calculation for C24-9 (HLB=13.9), an alcohol ethoxylate comprising a hydrophobic portion with an average 12 to 14 carbons (average=13), and a hydrophilic portion with nine ethoxylate groups, is shown below:

$$( Mp ) = 15 + ( 13 - 1 ) * 14 = 183$$

$$( Mh ) = 9 * 44 + 17 = 413$$

$$( M ) = Mp + Mh = 183 + 413 = 596$$

$$HLB = 20 * 413 / 596 = 13.9$$

The alkoxylated fatty alcohol materials useful in the detergent compositions herein typically have HLB values that range from about 12 to about 13.9.

### Method for Aging Samples and Measuring % Phase Split

An initial assessment of the phase stability of the sample is made prior to aging. After the initial assessment is complete, the glass scintillation vials containing the product samples are placed in temperature-controlled rooms at 50 C (+/−2 C) for 8 weeks. Samples are removed from the temperature-controlled rooms and allowed to equilibrate to room temperature. After the samples have equilibrated to room temperature, they are assessed for phase stability. If the sample is one continuous phase, no measurement is taken and a value of 100% is provided. If a sample is separated into multiple phases, the height of the total sample in the container is measured in mm. Then, the height of the bottom layered is measured in mm. The height of the bottom sample is then divided by the total height of the sample and multiplied by 100, providing a percentage of the bottom layer. The top layer percentage is then calculated by subtracting the percentage of the bottom layer from 100%. The samples are then placed back in the temperature-controlled room after each physical stability measurement is complete.

### Method for Measuring pH

The pH of the liquid fabric care product is measured using a Extech Instrument Model pH300 pH probe, available from W. W. Grainger, Inc. Lake Forrest Illinois. The pH probe is first properly calibrated using pH buffer solutions of pH 1.68, pH 4.00, and pH 7.00. The probe is then used to measure the neat liquid acid rinse product with no product dilution. The sample is measured at a temperature between 20 C-25 C. The probe is rinsed with deionized water and carefully wiped clean and dried in between reading the pH of different samples.

### EXAMPLES

### Example 1. Exemplary Method of Making Perfume Premix Compositions

A composition according to the present disclosure may be made according to the following method.

First, a perfume premix composition is prepared by mixing 72.72% by weight of a nonionic surfactant (as listed in Table A herein) and 27.27% desired fragrance materials¹ using an appropriately sized container used to contain the mixture. Mixing is done using an IKA RW 20D S1 overhead mixer, model RW20D-S1 and R 1325 four-bladed propeller stirrer, from VWR Randor Pennsylvania. The premix is made no more than 2 hours prior to use in completing the liquid acid rinse composition. ¹Fragrance materials are identified herein by their effective log P values and % of alcohol PRMs. The fragrance materials are all made of PRMs selected from the following list of PRMs available at Vigon International Inc. East Stroudsburg. Pennsylvania. USA:

2-SEC-BUTYL CYCLO HEXANONE, 4-TERTIARY BUTYL CYCLOHEXYL ACETATE, ALLYL CAPROATE, AMBER XTREME, AMBERTONIC, AMYL CINNAMIC ALDEHYDE, AQUAL, BENZYL ACETATE, BENZYL BUTYRATE, BENZYL SALICYLATE, BETA GAMMA HEXENOL, BOISAMBRENE FORTE, CETALOX, CIS 3 HEXENYL ACETATE, CITRONELLOL, CYCLO GALBANATE, CYCLO OCTENYL METHYL CARBONATE, CYMAL, DELTA DAMASCONE, DELTA MUSCENONE, DIHYDRO ISO JASMONATE, DIHYDRO MYRCENOL, DIMETHYL BENZYL CARBINYL ACETATE, DIMETHYL-2 6-HEPTAN-2-OL, ETHYL-2-METHYL BUTYRATE, ETHYL 2 METHYL PENTANOATE, ETHYL ACETOACETATE, ETHYL LINALOOL, ETHYL MALTOL, ETHYL TRIMETHYLCYCLOPENTENE BUTENOL, ETHYL VANILLIN, FLOR ACETATE, FRUCTALATE, FRUTENE, GAMMA DECALACTONE, GERANYL ACETATE, HABANOLIDE, HELIONAL, HELIOTROPIN, HELVETOLIDE, HEXYL CINNAMIC ALDEHYDE, HEXYL SALICYLATE, HYDROXYCITRONELLAL, ISO E SUPER, LAEVO CARVONE, LAEVO TRISANDOL, LAURIC ALDEHYDE, LIGUSTRAL OR TRIPLAL, LINALOOL, LINALYL ACETATE, MAYOL, MELONAL, METHYL CEDRYLONE, METHYL DIHYDRO JASMONATE, METHYL DIOXOLAN, METHYL NONYL ACETALDEHYDE, METHYL PHENYL CARBINYL ACETATE, NIRVANOL, NONALACTONE, NORLIMBANOL, OCTYL ALDEHYDE, PARA HYDROXY PHENYL BUTANONE, PHENOXY ETHYL ISO BUTYRATE, PHENYL ETHYL ALCOHOL, PHENYL HEXANOL, P.T. BUCINAL (LILIAL), PYRANOL, TERPINEOL, TRIETHYL CITRATE, UNDECALACTONE, UNDECAVERTOL, UNDECYL ALDEHYDE, VANILLIN, VERDOX

### Example 2. Exemplary Product Formulations

Exemplary formulations for liquid fabric care compositions were made by mixing² together the ingredients listed in the proportions listed in the Table 1 below.

TABLE 1

| Liquid Acid Rinse Composition | |
|---|---|
| Ingredients | (Wt %) |
| Citric Acid Solution ³ | 46.85% |
| Sodium Formate Solution ⁴ | 0.50% |
| Sodium Hydroxide Solution ⁵ | 4.10% |
| Propylene Glycol ⁶ | 5.29% |
| Sodium Cumenesulfonate Solution ⁷ | 2.35% |
| Nonionic Surfactant ⁸ | 0.11% |
| Perfume premix as described in | 5.50% |
| Example 1 ⁹ | |
| Water | To 100% |
| Product pH | 2.3-2.9 |

² An appropriately sized container is used to contain the mixture. Mixing is done using an IKA RW 20D S1 overhead mixer, model RW20D-S1 and R 1345 four-bladed propeller stirrer, from VWR Randor, Pennsylvania.
³ 50.5% active citric acid solution of food grade quality available from Tate and Lyle PLC, Dayton, Ohio
⁴ 30% active sodium formate solution created by mixing 30% by weight sodium formate powder, available from Perstorm Polyols Inc, Toledo, Kansas, with 70% by weight deionized water in an appropriately sized container used to contain the mixture.
⁵ 50% active sodium hydroxide solution membrane grade available from Formosa Plastics Corp, Baton Rouge, Louisiana
⁶ Bio-sourced grade available from Archer Daniels Midland, Decatur, Illinois
⁷ 45% active sodium cumenesulfonate solution available from Nease Corp, Harrison, Ohio
⁸ Various, as defined in the tables below by tradename
⁹ Various, as defined in the tables below by effective logP and % alcohols

The exemplary liquid fabric care compositions were then aged and tested for phase splitting as detailed herein. Table 2 contains phase stability test data at 4 weeks at 50° C. for liquid fabric care compositions that include perfume premixes made as detailed in Example 1, utilizing various nonionic surfactants and perfume compositions. A composition is considered stable is if it only has a single visible phase. A composition is considered not stable is it has more than one visible phase.

TABLE 2

| | Characteristics of the perfume composition | | | |
|---|---|---|---|---|
| Nonionic Surfactant | | Effective logP of | Effective logP | Effective logP of |
| Utilized in the | Effective logP of 2.25; | 4.24; 33.3% | of 4.87; 0% | 3.0; 40.0% |
| Composition | 23.7% alcohols | alcohols | alcohols | alcohols |
| Lutensol XP79 | Not Stable | Not Tested | Not Tested | Not Tested |
| Lutensol XP80 | Not Stable | Not Tested | Not Tested | Not Tested |
| Novel 1412-3 | Not Stable | Not Tested | Not Tested | Not Tested |
| Novel 1412-11 (NRE) | Not Stable | Not Tested | Not Tested | Not Tested |
| Tergitol 15-S-12 | Not Stable | Not Tested | Not Tested | Not Tested |
| Tergitol 15-S-20 | Not Stable | Not Tested | Not Tested | Not Tested |
| Novel 1214-9 (NRE) | Stable | Not Tested | Not Tested | Not Tested |
| Triton X-100 | Stable | Not Tested | Not Tested | Not Tested |
| Tergitol 15-S-7 | Not Stable | Not Stable | Not Stable | Not Stable |
| Terigol TMN-6 | Not Stable | Not Stable | Not Stable | Not Stable |
| Neodol 45-7 | Not Stable | Not Stable | Not Stable | Not Stable |
| Lutensol XP70 | Not Stable | Stable | Not Stable | Not Stable |
| Surfonic L24-7 (NRE) | Not Stable | Not Stable | Not Stable | Not Stable |
| Tergitol 15-S-9 | Stable | Stable | Stable | Not Stable |
| Tergitol NP-10 | Stable | Stable | Stable | Not Stable |
| Surfonic L24-9 (NRE) | Stable | Stable | Stable | Stable |
| Surfonic L24-9 | Stable | Stable | Stable | Stable |
| Alfonic 1214-7 | Stable | Stable | Stable | Not Stable |
| Alfonic 1214 -- 9 | Stable | Stable | Stable | Stable |

Table 3 contains phase stability test data at 4 weeks at 50° C. for liquid fabric care compositions that include perfume premixes made as detailed in Example 1, utilizing various nonionic surfactants and perfume compositions.

TABLE 3

| | Characteristics of the perfume composition | | |
|---|---|---|---|
| Nonionic Surfactant | | Effective logP of | Effective logP |
| Utilized in the | Effective logP of 2.96; | 1.38; 40% | of 1.40; 0% |
| Composition | 0% alcohols | alcohols | alcohols |
| Tergitol 15-S-7 | Not Stable | Not Stable | Not Stable |
| Tergitol TMN-6 | Not Stable | Not Stable | Not Stable |
| Neodol 45-7 | Not Stable | Stable | Not Stable |
| Lutensol XP70 | Not Stable | Not Stable | Not Stable |
| Surfonic L24-7 (NRE) | Not Stable | Stable | Stable |
| Tergitol 15-S-9 | Stable | Stable | Stable |
| Tergitol NP-10 | Stable | Stable | Stable |
| Surfonic L24-9 (NRE) | Stable | Stable | Stable |
| Surfonic L24-9 | Stable | Stable | Stable |
| Alfonic 1214-7 | Stable | Stable | Stable |
| Alfonic 1214 -- 9 | Stable | Stable | Stable |

Table 4 contains % phase split test data at 8 weeks at 50° C. for liquid fabric care compositions that include a perfume premix made as detailed in Example 1, utilizing Tergitol 15-S-7 and perfumes as listed.

TABLE 4

| | | Height | Height of | | |
|---|---|---|---|---|---|
| | | of | the | Vol. % | |
| | | Liquid | Bottom | of | Vol. % of |
| Perfume used with | | in Vial | Phase | Bottom | Top |
| Tergitol 15-S-7 | Description of Sample | (mm) | (mm) | Phase | Phase |
| Effective logP of 4.24; | Not stable; shows phase | 41.5 | 29.0 | 69.9% | 30.1% |
| 33.3% alcohols | separation, top layer more | | | | |
| | yellow than bottom | | | | |
| Effective logP of 4.87; | Not stable; shows phase | 43.0 | 30.5 | 70.9% | 29.1% |
| 0% alcohols | separation, top layer more | | | | |
| | yellow than bottom | | | | |
| Effective logP of 3.0; | Not stable; shows phase | 40.5 | 32.5 | 80.2% | 19.8% |
| 40.0% alcohols | separation, top layer more | | | | |
| | yellow than bottom | | | | |
| Effective logP of 2.96; | Not stable; shows phase | 44.0 | 35.0 | 79.5% | 20.5% |
| 0% alcohols | separation, top layer more | | | | |
| | yellow than bottom | | | | |
| Effective logP of 1.38; | Not stable; shows phase | 44.0 | 32.0 | 72.7% | 27.3% |
| 40% alcohols | separation, top layer more | | | | |
| | yellow than bottom | | | | |
| Effective logP of 1.40; | Not stable; shows phase | 45.5 | 34.0 | 74.7% | 25.3% |
| 0% alcohols | separation, top layer more | | | | |
| | yellow than bottom | | | | |

Table 5 contains % phase split test data at 8 weeks at 50° C. for liquid fabric care compositions that include a perfume premix made as detailed in Example 1, utilizing Tergitol 15-S-9 and perfumes as listed.

TABLE 5

| | | Height | Height of | | |
|---|---|---|---|---|---|
| | | of | the | Vol. % | |
| | | Liquid | Bottom | of | Vol. % of |
| Perfume used with | | in Vial | Phase | Bottom | Top |
| Tergitol 15-S-9 | Description of Sample | (mm) | (mm) | Phase | Phase |
| Effective logP of 4.24; | Stable, only one phase, no | N/A | N/A | N/A | N/A |
| 33.3% alcohols | distinct layers are visible | | | | |
| Effective logP of 4.87; | Stable, only one phase, no | N/A | N/A | N/A | N/A |
| 0% alcohols | distinct layers are visible | | | | |
| Effective logP of 3.0; | Stable, only one phase, no | N/A | N/A | N/A | N/A |
| 40.0% alcohols | distinct layers are visible | | | | |
| Effective logP of 2.96; | Stable, only one phase, no | N/A | N/A | N/A | N/A |
| 0% alcohols | distinct layers are visible | | | | |
| Effective logP of 1.38; | Stable, only one phase, no | N/A | N/A | N/A | N/A |
| 40% alcohols | distinct layers are visible | | | | |
| Effective logP of 1.40; | Stable, only one phase, no | N/A | N/A | N/A | N/A |
| 0% alcohols | distinct layers are visible | | | | |

Table 6 contains % phase split test data at 8 weeks at 50° C. for liquid fabric care compositions that include a perfume premix made as detailed in Example 1, utilizing Tergitol NP-10 and 5 perfumes as listed.

TABLE 6

| | | Height | Height of | | |
|---|---|---|---|---|---|
| | | of | the | Vol. % | |
| | | Liquid | Bottom | of | Vol. % of |
| Perfume used with | | in Vial | Phase | Bottom | Top |
| Tergitol NP-10 | Description of Sample | (mm) | (mm) | Phase | Phase |
| Effective logP of 4.24; | Stable, only one phase, no | N/A | N/A | N/A | N/A |
| 33.3% alcohols | distinct layers are visible | | | | |
| Effective logP of 4.87; | Stable, only one phase, no | N/A | N/A | N/A | N/A |
| 0% alcohols | distinct layers are visible | | | | |
| Effective logP of 3.0; | Stable, only one phase, no | N/A | N/A | N/A | N/A |
| 40.0% alcohols | distinct layers are visible | | | | |
| Effective logP of 2.96; | Stable, only one phase, no | N/A | N/A | N/A | N/A |
| 0% alcohols | distinct layers are visible | | | | |
| Effective logP of 1.38; | Stable, only one phase, no | N/A | N/A | N/A | N/A |
| 40% alcohols | distinct layers are visible | | | | |
| Effective logP of 1.40; | Stable, only one phase, no | N/A | N/A | N/A | N/A |
| 0% alcohols | distinct layers are visible | | | | |

Table 7 contains % phase split test data at 8 weeks at 50° C. for liquid fabric care compositions that include a perfume premix made as detailed in Example 1, utilizing Tergitol TMN-6 and perfumes as listed.

TABLE 7

| | | Height | Height of | | |
|---|---|---|---|---|---|
| | | of | the | Vol. % | |
| | | Liquid | Bottom | of | Vol. % of |
| Perfume used with | | in Vial | Phase | Bottom | Top |
| Tergitol TMN-6 | Description of Sample | (mm) | (mm) | Phase | Phase |
| Effective logP of 4.24; | Not stable; shows sphase | 42.0 | 35.0 | 83.3% | 16.7% |
| 33.3% alcohols | separation, top layer more | | | | |
| | yellow than bottom | | | | |
| Effective logP of 4.87; | Not stable; shows phase | 41.0 | 34.0 | 82.9% | 17.1% |
| 0% alcohols | separation, top layer more | | | | |
| | yellow than bottom | | | | |
| Effective logP of 3.0; | Not stable; shows phase | 42.5 | 38.0 | 89.4% | 10.6% |
| 40.0% alcohols | separation, top layer more | | | | |
| | yellow than bottom | | | | |
| Effective logP of 2.96; | Not stable; shows phase | 44.5 | 38.5 | 86.5% | 13.5% |
| 0% alcohols | separation, top layer more | | | | |
| | yellow than bottom | | | | |
| Effective logP of 1.38; | Not stable; shows phase | 42.5 | 34.5 | 81.2% | 18.8% |
| 40% alcohols | separation, top layer more | | | | |
| | yellow than bottom | | | | |
| Effective logP of 1.40; | Not stable; shows phase | 43.0 | 36.0 | 83.7% | 16.3% |
| 0% alcohols | separation, top layer more | | | | |
| | yellow than bottom | | | | |

Table 8 contains % phase split test data at 8 weeks at 50° C. for liquid fabric care compositions that include a perfume premix made as detailed in Example 1, utilizing Alfonic 1214-7 and perfumes as listed.

TABLE 8

| | | Height | Height of | | |
|---|---|---|---|---|---|
| | | of | the | Vol. % | |
| | | Liquid | Bottom | of | Vol. % of |
| Perfume used with | | in Vial | Phase | Bottom | Top |
| Alfonic 1214-7 | Description of Sample | (mm) | (mm) | Phase | Phase |
| Effective logP of 4.24; | One phase, small flaky | N/A | N/A | N/A | N/A |
| 33.3% alcohols | precipitates at the bottom | | | | |
| Effective logP of 4.87; | Stable, only one phase, no | N/A | N/A | N/A | N/A |
| 0% alcohols | distinct layers are visible | | | | |
| Effective logP of 3.0; | Stable, only one phase, no | N/A | N/A | N/A | N/A |
| 40.0% alcohols | distinct layers are visible | | | | |
| Effective logP of 2.96; | Stable, only one phase, no | N/A | N/A | N/A | N/A |
| 0% alcohols | distinct layers are visible | | | | |
| Effective logP of 1.38; | Stable, only one phase, no | N/A | N/A | N/A | N/A |
| 40% alcohols | distinct layers are visible | | | | |
| Effective logP of 1.40; | Stable, only one phase, no | N/A | N/A | N/A | N/A |
| 0% alcohols | distinct layers are visible | | | | |

Table 9 contains % phase split test data at 8 weeks at 50° C. for liquid fabric care compositions that include a perfume premix made as detailed in Example 1, utilizing Alfonic 1214-9 and perfumes as listed.

TABLE 9

| | | Height | Height of | | |
|---|---|---|---|---|---|
| | | of | the | Vol. % | |
| | | Liquid | Bottom | of | Vol. % of |
| Perfume used with | | in Vial | Phase | Bottom | Top |
| Alfonic 1214-9 | Description of Sample | (mm) | (mm) | Phase | Phase |
| Effective logP of 4.24; | Stable, only one phase, no | N/A | N/A | N/A | N/A |
| 33.3% alcohols | distinct layers are visible | | | | |
| Effective logP of 4.87; | Stable, only one phase, no | N/A | N/A | N/A | N/A |
| 0% alcohols | distinct layers are visible | | | | |
| Effective logP of 3.0; | Stable, only one phase, no | N/A | N/A | N/A | N/A |
| 40.0% alcohols | distinct layers are visible | | | | |
| Effective logP of 2.96; | Stable, only one phase, no | N/A | N/A | N/A | N/A |
| 0% alcohols | distinct layers are visible | | | | |
| Effective logP of 1.38; | Stable, only one phase, no | N/A | N/A | N/A | N/A |
| 40% alcohols | distinct layers are visible | | | | |
| Effective logP of 1.40; | Stable, only one phase, no | N/A | N/A | N/A | N/A |
| 0% alcohols | distinct layers are visible | | | | |

Table 10 contains % phase split test data at 8 weeks at 50° C. for liquid fabric care compositions that include a perfume premix made as detailed in Example 1, utilizing Lutensol XP 70 and perfumes as listed.

TABLE 10

| | | Height | Height of | | |
|---|---|---|---|---|---|
| | | of | the | Vol. % | |
| | | Liquid | Bottom | of | Vol. % of |
| Perfume used with | | in Vial | Phase | Bottom | Top |
| Lutensol XP 70 | Description of Sample | (mm) | (mm) | Phase | Phase |
| Effective logP of 4.24; | Stable, only one phase, no | N/A | N/A | N/A | N/A |
| 33.3% alcohols | distinct layers are visible | | | | |
| Effective logP of 4.87; | Stable, only one phase, no | N/A | N/A | N/A | N/A |
| 0% alcohols | distinct layers are visible | | | | |
| Effective logP of 3.0; | Not stable; shows phase | 43.5 | 35.0 | 80.5% | 19.5% |
| 40.0% alcohols | separation, top layer more | | | | |
| | yellow than bottom | | | | |
| Effective logP of 2.96; | Not stable; shows phase | 43.0 | 34.0 | 79.1% | 20.9% |
| 0% alcohols | separation, top layer more | | | | |
| | yellow than bottom | | | | |
| Effective logP of 1.38; | N/A - test data was lost | N/A | N/A | N/A | N/A |
| 40% alcohols | | | | | |
| Effective logP of 1.40; | Not stable; shows phase | 44.5 | 32.0 | 71.9% | 28.1% |
| 0% alcohols | separation, top layer more | | | | |
| | yellow than bottom | | | | |

Table 11 contains % phase split test data at 8 weeks at 50° C. for liquid fabric care compositions that include a perfume premix made as detailed in Example 1, utilizing Neodol 45-7 and perfumes as listed.

TABLE 11

| | | Height | Height of | | |
|---|---|---|---|---|---|
| | | of | the | Vol. % | |
| | | Liquid | Bottom | of | Vol. % of |
| Perfume used with | | in Vial | Phase | Bottom | Top |
| Neodol 45-7 | Description of Sample | (mm) | (mm) | Phase | Phase |
| Effective logP of 4.24; | Only one phase but product is | N/A | N/A | N/A | N/A |
| 33.3% alcohols | not stable because it is opaque, | | | | |
| | therefore nothing to measure | | | | |
| Effective logP of 4.87; | Only one phase but product is | N/A | N/A | N/A | N/A |
| 0% alcohols | not stable because it is opaque, | | | | |
| | therefore nothing to measure | | | | |
| Effective logP of 3.0; | Not stable; shows phase | 45.0 | 29.5 | 65.6% | 34.4% |
| 40.0% alcohols | separation, top layer more | | | | |
| | yellow than bottom | | | | |
| Effective logP of 2.96; | Not stable; shows phase | 44.5 | 28.5 | 64.0% | 36.0% |
| 0% alcohols | separation, top layer more | | | | |
| | yellow than bottom | | | | |
| Effective logP of 1.38; | Stable, only one phase, no | N/A | N/A | N/A | N/A |
| 40% alcohols | distinct layers are visible | | | | |
| Effective logP of 1.40; | Stable, only one phase, no | N/A | N/A | N/A | N/A |
| 0% alcohols | distinct layers are visible | | | | |

Table 12 contains % phase split test data at 8 weeks at 50° C. for liquid fabric care compositions that include a perfume premix made as detailed in Example 1, utilizing Surfonic 24-7 (NRE) and perfumes as listed.

TABLE 12

| | | Height | Height of | | |
|---|---|---|---|---|---|
| | | of | the | Vol. % | |
| Perfume used with | | Liquid | Bottom | of | Vol. % of |
| Surfonic 24-7 | | in Vial | Phase | Bottom | Top |
| (NRE) | Description of Sample | (mm) | (mm) | Phase | Phase |
| Effective logP of 4.24; | Not stable; shows phase | 43.5 | 29.5 | 67.8% | 32.2% |
| 33.3% alcohols | separation, top layer more | | | | |
| | yellow than bottom | | | | |
| Effective logP of 4.87; | Not stable; shows phase | 41.0 | 28.0 | 68.3% | 31.7% |
| 0% alcohols | separation, top layer more | | | | |
| | yellow than bottom | | | | |
| Effective logP of 3.0; | Not stable; shows phase | 43.0 | 31.5 | 73.3% | 26.7% |
| 40.0% alcohols | separation, top layer more | | | | |
| | yellow than bottom | | | | |
| Effective logP of 2.96; | Not stable; shows phase | 47.0 | 32.5 | 69.1% | 30.9% |
| 0% alcohols | separation, top layer more | | | | |
| | yellow than bottom | | | | |
| Effective logP of 1.38; | Stable, only one phase, no | N/A | N/A | N/A | N/A |
| 40% alcohols | distinct layers are visible | | | | |
| Effective logP of | Stable, only one phase, no | N/A | N/A | N/A | N/A |
| 1.40; 0% alcohols | distinct layers are visible | | | | |

Table 13 contains % phase split test data at 8 weeks at 50° C. for liquid fabric care compositions that include a perfume premix made as detailed in Example 1, utilizing Surfonic L24-9 and perfumes as listed.

TABLE 13

| | | Height | Height of | | |
|---|---|---|---|---|---|
| | | of | the | Vol. % | |
| | | Liquid | Bottom | of | Vol. % of |
| Perfume used with | | in Vial | Phase | Bottom | Top |
| Surfonic L24-9 | Description of Sample | (mm) | (mm) | Phase | Phase |
| Effective logP of 4.24; | Stable, only one phase, no | N/A | N/A | N/A | N/A |
| 33.3% alcohols | distinct layers are visible | | | | |
| Effective logP of 4.87; | Stable, only one phase, no | N/A | N/A | N/A | N/A |
| 0% alcohols | distinct layers are visible | | | | |
| Effective logP of 3.0; | Stable, only one phase, no | N/A | N/A | N/A | N/A |
| 40.0% alcohols | distinct layers are visible | | | | |
| Effective logP of 2.96; | Stable, only one phase, no | N/A | N/A | N/A | N/A |
| 0% alcohols | distinct layers are visible | | | | |
| Effective logP of 1.38; | Stable, only one phase, no | N/A | N/A | N/A | N/A |
| 40% alcohols | distinct layers are visible | | | | |
| Effective logP of 1.40; | Stable, only one phase, no | N/A | N/A | N/A | N/A |
| 0% alcohols | distinct layers are visible | | | | |

Table 14 contains % phase split test data at 8 weeks at 50° C. for liquid fabric care compositions that include a perfume premix made as detailed in Example 1, utilizing Surfonic L24-9 (NRE) and perfumes as listed.

TABLE 14

| | | Height | Height of | | |
|---|---|---|---|---|---|
| | | of | the | Vol. % | |
| Perfume used with | | Liquid | Bottom | of | Vol. % of |
| Surfonic L24-9 | | in Vial | Phase | Bottom | Top |
| (LFE) | Description of Sample | (mm) | (mm) | Phase | Phase |
| Effective logP of 4.24; | Stable, only one phase, no | N/A | N/A | N/A | N/A |
| 33.3% alcohols | distinct layers are visible | | | | |
| Effective logP of 4.87; | Stable, only one phase, no | N/A | N/A | N/A | N/A |
| 0% alcohols | distinct layers are visible | | | | |
| Effective logP of 3.0; | Stable, only one phase, no | N/A | N/A | N/A | N/A |
| 40.0% alcohols | distinct layers are visible | | | | |
| Effective logP of 2.96; | Stable, only one phase, no | N/A | N/A | N/A | N/A |
| 0% alcohols | distinct layers are visible | | | | |
| Effective logP of 1.38; | Stable, only one phase, no | N/A | N/A | N/A | N/A |
| 40% alcohols | distinct layers are visible | | | | |
| Effective logP of 1.40; | Stable, only one phase, no | N/A | N/A | N/A | N/A |
| 0% alcohols | distinct layers are visible | | | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid fabric care composition comprising:
from about 10% to about 50%, by weight of the liquid fabric care composition, of citric acid and/or a salt thereof,
from about 0.01% to about 5%, but weight of the liquid fabric care composition, of fragrance material,
from about 30% to about 90%, by weight of the liquid fabric care composition, of water,
from about 0.1% to about 8%, by weight of the liquid fabric care composition, of nonionic surfactant,
wherein the nonionic surfactant is an ethoxylated fatty alcohol that has an HLB of between 12.0 and 13.9 and a Stability Parameter between 11.0 and 25.0, wherein:
Stability Parameter=(Average Cloud Point/(HLB−Weighted Average Degree of Ethoxylation)); and
wherein the liquid fabric care composition is characterized by a neat pH of from about 2 to about 6.

2. The liquid fabric care composition of claim 1, wherein the composition is substantially free of anionic surfactant, dyes, bleaching systems, and fabric softening materials.

3. The liquid fabric care composition of claim 1, wherein the Stability Parameter is between 13.0 and 20.0.

4. The liquid fabric care composition of claim 1, wherein the Stability Parameter is between 18.0 and 19.0.

5. The liquid fabric care composition of claim 1, wherein the HLB is between 12.5 and 13.5.

6. The liquid fabric care composition of claim 1, wherein the HLB is about 13.0.

7. The liquid fabric care composition of claim 1, wherein the Average Cloud Point is between 60.0 and 90.0.

8. The liquid fabric care composition of claim 1, wherein the Average Cloud Point is about 75.

9. The liquid fabric care composition of claim 1, wherein the Weighted Average Degree of Ethoxylation is between 7 and 10.

10. The liquid fabric care composition of claim 1, wherein the Weighted Average Degree of Ethoxylation is about 9.

11. The liquid fabric care composition of claim 1, wherein the fragrance material comprises alcohols, aldehydes, esters, and ketones.

12. The liquid fabric care composition of claim 11, wherein the fragrance material comprises between about 20% and about 25% alcohols with an effective log P of between about 1.5 to about 3.5, between about 25% and about 30% aldehydes with an effective log P of between about 2.0 to about 4.0, between about 35% and about 40% esters with an effective log P of between about 2.0 to about 4.0, and between about 5% and about 10% ketones with an effective log P of between about 2.0 to 4.0.

13. The liquid fabric care composition of claim 11, wherein the fragrance material comprises between about 21.0% and about 23.0% alcohols with an effective log P of between about 2.0 and about 2.5, between about 26.0% and about 28.0% aldehydes with an effective log P of between about 2.3 and about 2.8, between about 37.0% and about 39.0% esters with an effective log P of between about 1.8 and about 2.3, and between about 6.0% and 8.0% ketones with an effective log P of between about 1.4 and about 1.7.

14. The liquid fabric care composition of claim 11, wherein the fragrance material is characterized by a log P of about 2.25 and comprises about 23.7% alcohols.

15. The liquid fabric care composition of claim 1, wherein the composition further comprises between about 1.0% and about 5.0% propylene glycol.

16. The liquid fabric care composition of claim 1, wherein the composition is characterized by a reserve acidity measured to a pH=4.0 of about 1 to about 4.

17. The liquid fabric care composition of claim 1, wherein the ethoxylated fatty alcohol is linear.

18. The liquid fabric care composition of claim 1, wherein the composition is characterized by a viscosity of less than 100 cps, as determined by rotational viscometry using a Brookfield viscometer and ASTM D 2196-99 at 60 RPM and 22° C.

19. The liquid fabric care composition of claim 1, wherein the ratio of the % of fragrance material, by weight of the liquid fabric care composition, to the % of nonionic surfactant, by weight of the liquid care composition, is about 0.375.

20. The liquid fabric care composition of claim 1, wherein the composition further comprises between 1.0% and 5.0% stabilizer.
